(19) United States
(12) Patent Application Publication
(10) Pub. No.: US 2024/0100684 A1
(43) Pub. Date: Mar. 28, 2024

(54) TOOL ACCESSORY STORAGE ASSEMBLY

(71) Applicant: Apex Brands, Inc., Apex, NC (US)

(72) Inventors: Jeremiah Hickman, Columbia, SC (US); Jason D. Benson, Lexington, SC (US)

(21) Appl. No.: 18/242,086

(22) Filed: Sep. 5, 2023

Related U.S. Application Data
(60) Provisional application No. 63/409,307, filed on Sep. 23, 2022.

(51) Int. Cl. B25H 3/02

(52) U.S. Cl. CPC B25H 3/02

(57) ABSTRACT

A storage assembly for a tool accessory may include a cover member configured to cover a first end of the tool accessory, a base portion configured to retain a second end of the tool accessory in an orifice, and a retention assembly which may slidably operably couple the cover member to the base portion. The retention assembly may include a first protrusion which may be disposed at the base portion, a guide channel which may be disposed at the cover member, and a first reception slot which may extend substantially perpendicular to the guide channel. The guide channel may be substantially parallel to a longitudinal axis of the storage assembly. The first protrusion may interface with the guide channel and the first reception slot. The first protrusion may be retainable in the first reception slot responsive to rotating the base portion relative to the cover member.

### CROSS REFERENCE TO RELATED APPLICATION

This application claims priority to U.S. provisional application No. 63/409,307 filed Sep. 23, 2022, the entire contents of which are incorporated herein by reference.

### TECHNICAL FIELD

Example embodiments generally relate to tool accessories and, in particular, relate to a storage assembly having the ability to support a tool accessory.

### BACKGROUND

Drilling products are commonly used in both commercial and private settings to drill holes of various sizes and purposes into lumber or other working media. Typically employed in a construction setting, drilling products are most often driven by a driving device with an electric motor that applies torque to a drilling product to rotate the drilling product at relatively high speeds. The drilling product may be an example of a tool accessory, and may include a cutting portion that engages lumber or another medium in order to bore a hole in the medium as the drilling product is rotated at high speed and pressed into the medium to a desired bore depth. In other cases, other tool accessories may be adapted to perform various construction related tasks with lumber or other working media. In either case, the tool accessory may be removable from the driving device and may be interchanged with a tool accessory of a different type or size.

Tool accessories are often used in many different forms, with those that bore holes and those that cut being the most common. In this regard, switching between tool accessories, such as moving from a smaller drilling product to a larger one, may be a common occurrence. For this reason, an operator may have many different tool accessories for use in different scenarios. Thus, in order to stay organized, tool accessories may need to be stored in a secure place when not in use. It may be desirable to improve a storage assembly for tool accessories.

### BRIEF SUMMARY OF SOME EXAMPLES

In an example embodiment, a storage assembly for a tool accessory may be provided. The storage assembly may include a cover member which may be configured to cover a first end of the tool accessory, a base portion which may be configured to retain a second end of the tool accessory in an orifice, and a retention assembly which may slidably operably couple the cover member to the base portion. The retention assembly may include a first protrusion which may be disposed at the base portion, a guide channel which may be disposed at the cover member, and a first reception slot which may extend substantially perpendicular to the guide channel. The guide channel may be substantially parallel to a longitudinal axis of the storage assembly. The first protrusion may interface with the guide channel and the first reception slot. The first protrusion may be retainable in the first reception slot responsive to rotating the base portion relative to the cover member.

In another example embodiment, a base portion configured to slidably operably couple with a cover member of a tool accessory storage assembly may be provided. The base portion may include a first half and a second half which may be pivotally operably coupled to each other via a living hinge, an orifice which may be disposed opposite the living hinge to retain a tool accessory between the first half and the second half when the first and second halves may be proximate to each other, and a first protrusion which may be disposed on the first half or the second half and may interface with a guide channel and a first reception slot of the cover member. The first protrusion may be retainable in the first reception slot responsive to rotating the base portion relative to the cover member.

In another example embodiment, a cover member which may be configured to slidably operably couple with a base portion of a tool accessory storage assembly to cover a tool accessory may be provided. The cover member may include a unitary molded tube, a guide channel which may extend substantially parallel to a longitudinal axis of the storage assembly, and a first reception slot which may extend substantially perpendicular to the guide channel. The guide channel may interface with a first protrusion of the base portion. The first reception slot may retain the first protrusion responsive to rotating the cover member relative to the base portion.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a perspective view of a storage assembly according to an example embodiment;

FIG. 2 illustrates a perspective view of the storage assembly according to an example embodiment;

FIG. 3 illustrates a perspective view of a base portion according to an example embodiment;

FIG. 4 illustrates a perspective view of a cover member according to an example embodiment;

FIG. 5 illustrates a plan view of a guide channel according to an example embodiment;

FIG. 6 illustrates a perspective view of the storage assembly according to an example embodiment;

FIG. 7 illustrates a perspective view of the base portion according to an example embodiment;

FIG. 8 illustrates a perspective view of the storage assembly according to an example embodiment;

FIG. 9 is a front view of the storage assembly of FIG. 8;

FIG. 10 is a rear view of the storage assembly of FIG. 8;

FIG. 11 is a left side view of the storage assembly of FIG. 8;

FIG. 12 is a right side view of the storage assembly of FIG. 8;

FIG. 13 is a top view of the storage assembly of FIG. 8; and

FIG. 14 is a bottom view of the storage assembly of FIG. 8.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

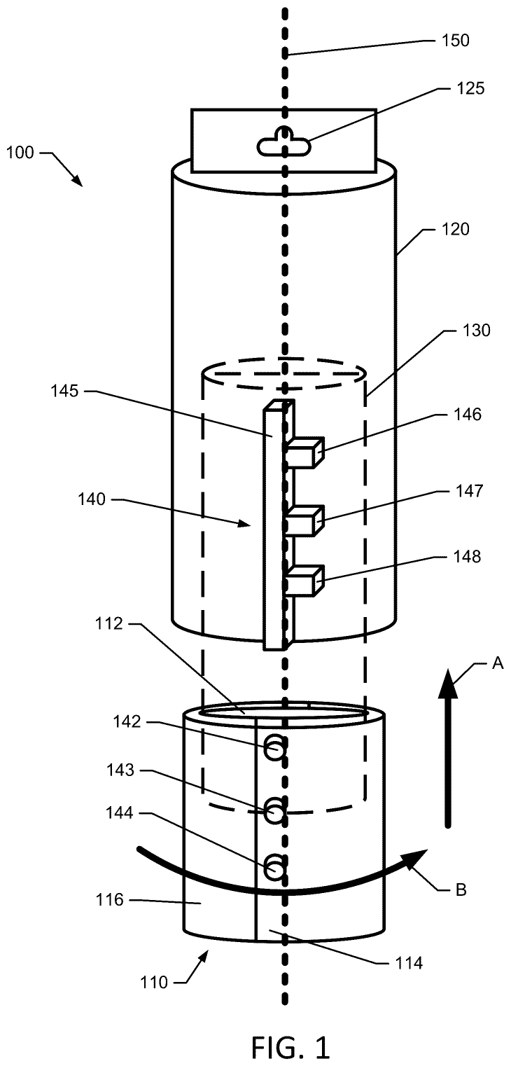

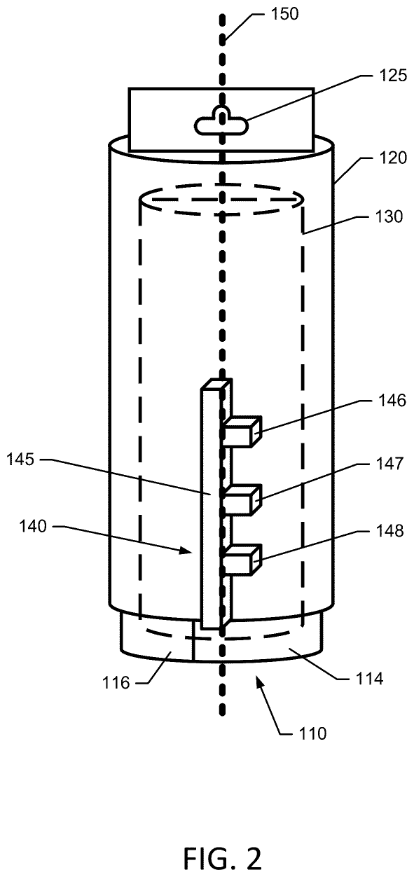

FIGS. 1 and 2 illustrate a perspective view of a storage assembly 100 according to an example embodiment. As shown in FIG. 1, the storage assembly 100 may include a base portion 110, a cover member 120, a tool accessory 130, and a retention assembly 140. The base portion 110 may be separate from the cover member 120, but may slidably operably couple with the cover member 120 to enclose the tool accessory 130, as shown in FIG. 2. Responsive to the base portion 110 and the cover member 120 being axially aligned along a longitudinal axis 150 of the storage assembly 100, the base portion 110 may slide into the cover member 120 at a first end of the cover member 120 in the direction indicated by arrow A. Responsive to the base portion 110 sliding into the cover member 120, the retention assembly 140 may retain the base portion 110 in the cover member 120. In an example embodiment, the tool accessory 130 may be a drilling product, a cutting product, or any other similar example of a workpiece member for a tool.

In an example embodiment, the base portion 110 and the cover member 120 may each be substantially hollow and cylindrical in shape. In this regard, an outer diameter of the base portion 110 may be less than an inner diameter of the cover member 120. Additionally, the base portion 110 may include an orifice 112 formed in a middle of the base portion 110. The orifice 112 may be substantially circular in shape and may retain the tool accessory 130 therein. Thus, an inner diameter of the orifice 112 may be sized to retain the tool accessory 130 while the base portion 110 may slide into, and operably couple with, the cover member 120. In some embodiments, the orifice 112 may further include a receptacle disposed therein in order to removably retain the tool accessory 130 within the base portion 110. In some cases, the receptacle may be molded into the orifice 112 to provide a more secure operable coupling between the base portion 110 and the tool accessory 130. In some other cases, the receptacle may be formed separately from the base portion 110, and may be removable from the base portion 110 when the base portion 110 is in the open position. In the position where the base portion 110 is inserted into the cover member 120, and the tool accessory 130 is enclosed by the storage assembly 100, a first end of the tool accessory 130 may be proximate to the cover member 120 and a second end of the tool accessory 130 may be held by the orifice 112 within the base portion 110. In some embodiments, the cover member 120 and the base portion 110 may each be closed off at their respective second ends, creating an enclosed space within the storage assembly 100 for the tool accessory 130 to be stored.

The retention assembly 140 may include a first protrusion 142, a guide channel 145, and a first reception slot 146. In some embodiments, the first protrusion 142 may be disposed at the base portion 110 while the guide channel 145 and the first reception slot 146 may both be disposed at the cover member 120. In some cases, the guide channel 145 may be disposed substantially parallel to the longitudinal axis 150. In this regard, the first protrusion 142 may interface with the guide channel 145 while the base portion 110 slides into the cover member 120. The first reception slot 146 may be connected to the guide channel 145 such that the first protrusion 142 may move from the guide channel 145 into the first reception slot 146. In some cases, the first reception slot 146 may extend substantially perpendicular to the guide channel 145 and thus also to the longitudinal axis 150. Accordingly, the first protrusion 142 may enter the first reception slot 146 from the guide channel 145 responsive to the base portion 110 rotating relative to the cover member 120 in the direction depicted by arrow B in FIG. 1 after the base portion 110 has already been inserted into the cover member 120. The first reception slot 146 may require less than 90° of rotation of the base portion 110 relative to the cover member 120 to retain the first protrusion 142 in the first reception slot 146. In this regard, the rotation of less than 90° may reduce the time and effort required by the operator of the tool accessory 130 to insert and remove the base portion 110 into and out of the cover member 120, respectively. As such, the base portion 110 may be inserted into, and removed from, the cover member 120 responsive to a small (less than 90°) rotation followed by a sliding action of the base portion 110 relative to the cover member 120. Thus, the process of inserting and removing the base portion 110 as described herein may be less labor and time intensive for the operator as opposed to a storage assembly 100 where the base portion 110 may operably couple to the cover member 120 via a threaded connection. A threaded operable coupling of the base portion 110 to the cover member 120 may require numerous full rotations of the base portion 110 relative to the cover member 120 in order to properly insert and remove the base portion 110 from the cover member 120, which may make the process of using the storage assembly 100 more time-consuming.

Responsive to inserting the base portion 110 into the cover member 120 so that the first protrusion 142 interfaces with the guide channel 145, the tool accessory 130 may be enclosed within the storage assembly 100 as depicted by FIG. 2. Thus, in order to secure the base portion 110 to the cover member 120, the base portion 110 may be rotated relative to the cover member 120 and the first protrusion 142 may therefore be retained in the first reception slot 146. In some embodiments, the cover member 120 may also include a display interface 125 disposed at the second end of the cover member 120. The display interface 125 may include a bore through a portion of the cover member 120 that extends perpendicularly away from the second end of the cover member 120. In some cases, the bore may be circular in shape. In some other cases, the bore may be T shaped to accommodate an alternatively shaped merchandise display support extending through the bore. As such, the display interface 125 may facilitate mounting the storage assembly 100 on a merchandise display, or in some cases, may also facilitate mounting the storage assembly 100 in other storage settings that may suit an operator of the tool accessory 130.

In some embodiments, the retention assembly may also include second and third protrusions (143, 144) and second and third reception slots (147, 148). In this case, the first, second and third protrusions (142, 143, 144) may be disposed spaced apart from each other along a line that extends parallel to the longitudinal axis 150. As such, the first, second and third protrusions (142, 143, 144) may enter the guide channel 145 responsive to the base portion 110 being inserted into the cover member 120. In some cases, the first, second and third reception slots (146, 147, 148) may be disposed with the same spacing between each respective slot as may be applied to the first, second and third protrusions (142, 143, 144). In this regard, the first, second and third protrusions (142, 143, 144) may simultaneously enter the first, second and third reception slots (146, 147, 148) responsive to the rotation of the base portion 110 relative to the cover member 120. In some embodiments, the rotation of the base portion 110 may not exceed 90° relative to the cover member 120 in order to secure the base portion 110 and the cover member 120 together. Similar to the embodiment described above, the rotation of less than 90° may reduce the time and effort required by the operator of the tool accessory 130 to insert and remove the base portion 110 into and out of the cover member 120, respectively. As such, the base portion 110 may be inserted into, and removed from, the cover member 120 responsive to a small (less than 90°) rotation followed by a sliding action of the base portion 110 relative to the cover member 120. Thus, the process of inserting and removing the base portion 110 as described herein may be less labor and time intensive for the operator as opposed to a storage assembly 100 where the base portion 110 may operably couple to the cover member 120 via a threaded connection. A threaded operable coupling of the base portion 110 to the cover member 120 may require numerous full rotations of the base portion 110 relative to the cover member 120 in order to properly insert and remove the base portion 110 from the cover member 120, which may make the process of using the storage assembly 100 more time-consuming.

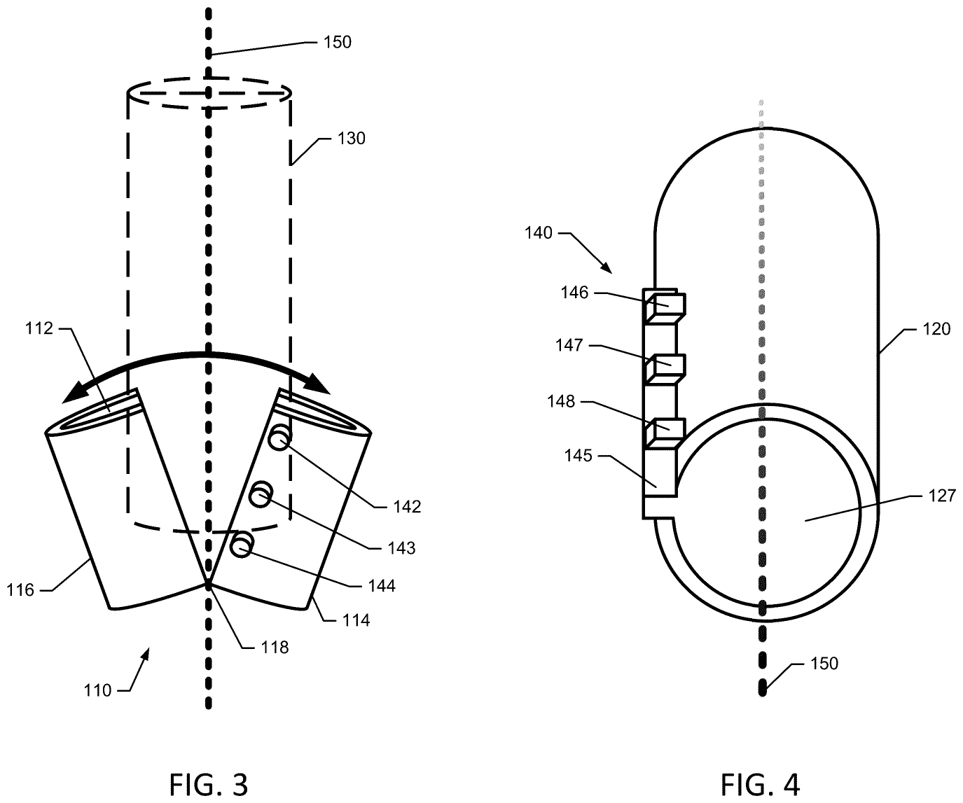

FIG. 3 illustrates a perspective view of the base portion 110 according to an example embodiment. In the example embodiment of FIG. 3, the base portion 110 may include a first half 114 and a second half 116. The first and second halves (114, 116) of the base portion 110 may be separated from each other along a plane that contains the longitudinal axis 150 of the storage assembly 100. In an example embodiment, the first half 114 and the second half 116 may be symmetric with each other about the longitudinal axis 150 of the storage assembly 100. In some cases, the first half 114 and the second half 116 may pivotally operably couple to each other via a living hinge 118 disposed at the second end of the base portion, opposite the orifice 112. The orifice 112 may be formed between the first half 114 and the second half 116 when the base portion 110 is in the closed position, and the longitudinal axis 150 may extend through the center of the orifice 112 accordingly. The first and second halves (114, 116) of the base portion 110 may pivot away from one another about the living hinge 118 to put the base portion 110 into the open position, and thus the orifice 112 may be split open to insert or remove the tool accessory 130 into or from the base portion 110. In this regard, the base portion 110 may pivot about the living hinge 118 alternating between open and closed positions. The base portion 110 in FIG. 3 is depicted in the open position. In the open position, the first half 114 and the second half 116 may only be operably coupled to one another via the living hinge 118. In the closed position, the first half 114 and the second half 116 may secure to each other via a snap fit, such that the first half 114 may be operably coupled to the second half 116 via the snap fit in addition to the living hinge 118. In this regard, the living hinge 118 may be integrally formed from the second end of the base portion 110. The living hinge 118 may therefore include the same material that may comprise the first and second halves (114, 116).

In some cases, the first protrusion 142 may solely be disposed at the first half 114 of the base portion 110, and in another case, the first protrusion 142 may solely be disposed at the second half 116. In some embodiments, the first protrusion 142 may be disposed at both the first half 114 and the second half 116. In this regard, the first protrusion 142 may split into two halves when the base portion 110 is in the open position responsive to the first half 114 pivoting away from the second half 116 about the living hinge 118. Thus, in such embodiments, the first protrusion 142 may only be complete when the base portion 110 is in the closed position. In some cases, the base portion 110 may enter the open position only when the base portion 110 is not inserted into the cover member 120. In other words, the base portion 110 may only slide into the cover member 120 when the base portion is in the closed position. As such, the cover member 120 may help bias the first and second halves (114, 116) together to keep the base portion 110 in the closed position when the base portion 110 is inserted inside the cover member 120.

FIG. 4 illustrates a perspective view of the cover member 120 according to an example embodiment. As shown in FIG. 4, the cover member 120 may be a unitary molded tube with which the base portion 110 may slidably operably couple. In this regard, the cover member 120 and the base portion 110 may both be made from a plastic polymer material via a process of injection molding. Accordingly, the cover member 120 may be formed with the center 127 of the cover member 120 almost entirely hollow to allow for the insertion of the base portion 110 therein. In some embodiments, the cover member 120 may be transparent, and made from a clear plastic polymer. In this regard, the tool accessory 130 may be viewed and identified by the operator without removing the base portion 110 from the cover member 120.

FIG. 4 also depicts the guide channel 145. As described above, the guide channel 145 may interface with the first protrusion 142, and in some embodiments, the second and third protrusions (143, 144). Thus, the guide channel 145 may provide an extension of the center 127 of the cover member 120. In other words, the guide channel 145 may be similar to a “tunnel” carved into the sidewall of the center 127 of the cover member 120 so that the first protrusion 142 may extend from the center 127 of the cover member 120 to the guide channel 145.

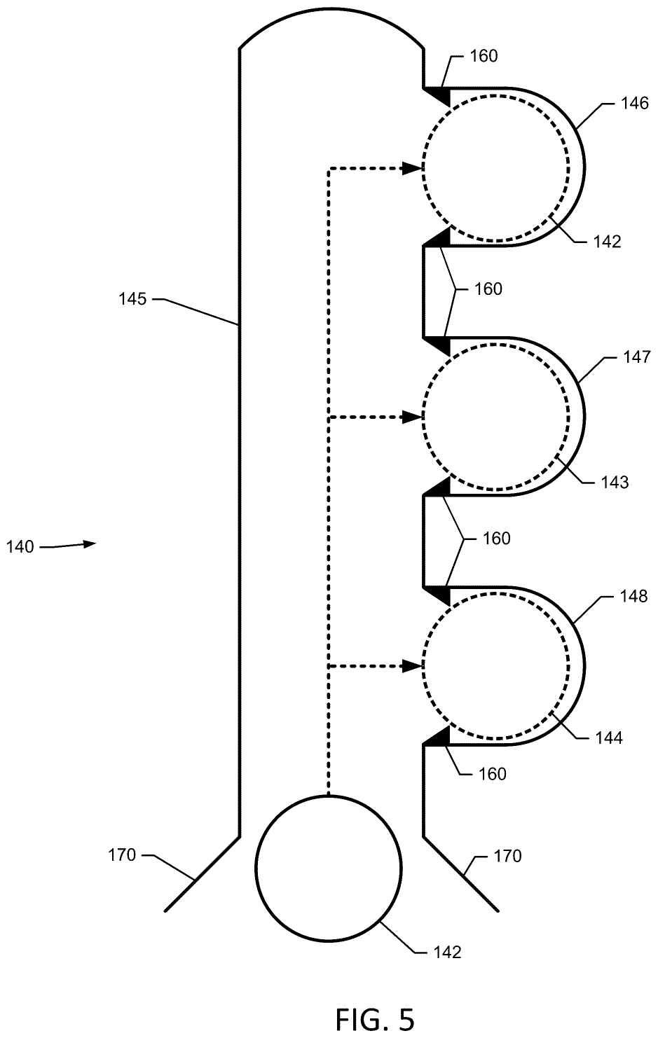

FIG. 5 illustrates a plan view of the guide channel according to an example embodiment. In the example embodiment of FIG. 5, the first reception slot 146 may include a detent 160 to retain the first protrusion 142 in the first reception slot 146 via a snap fit. In other words, the detent 160 may essentially increase the amount of force required to move the first protrusion 142 into and out of the first reception slot 146. In this regard, responsive to rotating the base portion 110 relative to the cover member 120, the first protrusion 142 may move from the guide channel 145, passed the detent 160, and into the first reception slot 146. The operator of the storage assembly 100 may feel or hear physical or audible feedback as the first protrusion 142 moves passed the detent 160 going into and out of the first reception slot 146. In some embodiments, the detent 160 may be fixed in place. In this regard, the detent 160 may be formed as part of a sidewall of the guide channel 145 or the first reception slot 146. In other cases, the detent 160 may be added on to the sidewall of the guide channel 145 or the first reception slot 146 and secured thereto via an adhesive or fastener. In an example embodiment, the detent 160 may also be movable. In this regard, the detent 160 may be a ball and socket type detent 160. In other words, the detent 160 may include a ball that may be biased into the first reception slot 146 or into the guide channel 145. As the first protrusion 142 moves through the guide channel 145 and the first reception slot 146, the first protrusion 142 may apply a force to the detent 160 that pushes the ball into a socket, against the bias on the ball. Thus, the first protrusion 142 may move passed the detent 160, and responsive to the first protrusion 142 passing the detent 160, the ball may be biased back into the pathway of the guide channel 145 or the first reception slot 146. In any case, the detent 160 may facilitate securing the base portion 110 in the cover member 120 and therefore resisting the movement of the first protrusion 142 relative to the guide channel 145 or the first reception slot 146.

In some cases, the guide channel 145 may include one or more sloped surfaces 170 forming an entryway to enable the first protrusion 142 to enter the guide channel 145 responsive to the base portion 110 sliding into the cover member 120. In this regard, the sloped surface 170 may lead into the guide channel 145. Thus, for example, the one or more sloped surfaces 170 will tend to guide the first protrusion 142 into the guide channel 145 when the base portion 110 is inserted into the cover member 120. This may help ensure that the first protrusion 142 can easily reenter the guide channel 145 after being removed from the guide channel 145, potentially as a result of the base portion 110 being removed from the cover member 120.

In an example embodiment, the second and third reception slots (147, 148) may also each include a respective detent 160. In such cases, the detent 160 of each of the second and third reception slots (147, 148) may be substantially similar to, if not the same as, the detent 160 from the first reception slot 146 described above. As such, the detent 160 of each of the second and third reception slots (147, 148) may secure the second and third protrusions (143, 144) into the second and third reception slots (147, 148), respectively. In some cases, the first, second and third protrusions (142, 143, 144) may enter the first, second and third reception slots (146, 147, 148), respectively, simultaneously. As described above in relation to the detent 160 for the first reception slot 146, the detent 160 in each of the second and third reception slots (147, 148) may be a fixed geometric feature in some cases, or may be movable in some other embodiments.

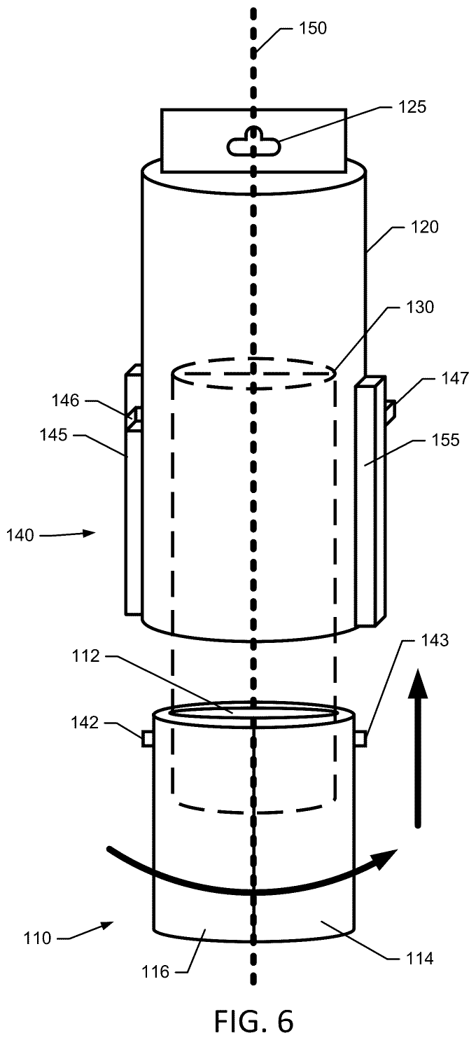

FIG. 6 illustrates a perspective view of the storage assembly 100 according to an example embodiment. In contrast to the embodiments shown in FIGS. 1-5 and 7, in the embodiment shown in FIG. 6, the retention assembly 140 may include the first protrusion 142 and the second protrusion 143 disposed 180° apart from each other relative to the longitudinal axis 150, and on opposite sides of the base portion 110. In this regard, the retention assembly 140 may further include a second guide channel 155 which may be operably coupled to the second reception slot 147 on an opposite side of the cover member 120 from the guide channel 145. In some cases, the guide channel 145 and the second guide channel 155 may also be disposed 180° apart on the cover member 120 relative to the longitudinal axis 150. In some other cases, the first and second protrusions (142, 143) may not be disposed on opposite sides of the base portion 110. The first and second protrusions (142, 143) may, for example, be disposed 90° apart from one another relative to the longitudinal axis 150. In this regard, the guide channel 145 and the second guide channel 155 may be disposed at the same angular separation from one another that is applied to the first and second protrusions (142, 143). Accordingly, the first and second protrusions (142, 143) may interface with the guide channel 145 and the second guide channel 155 responsive to the base portion 110 operably coupling with the cover member 120.

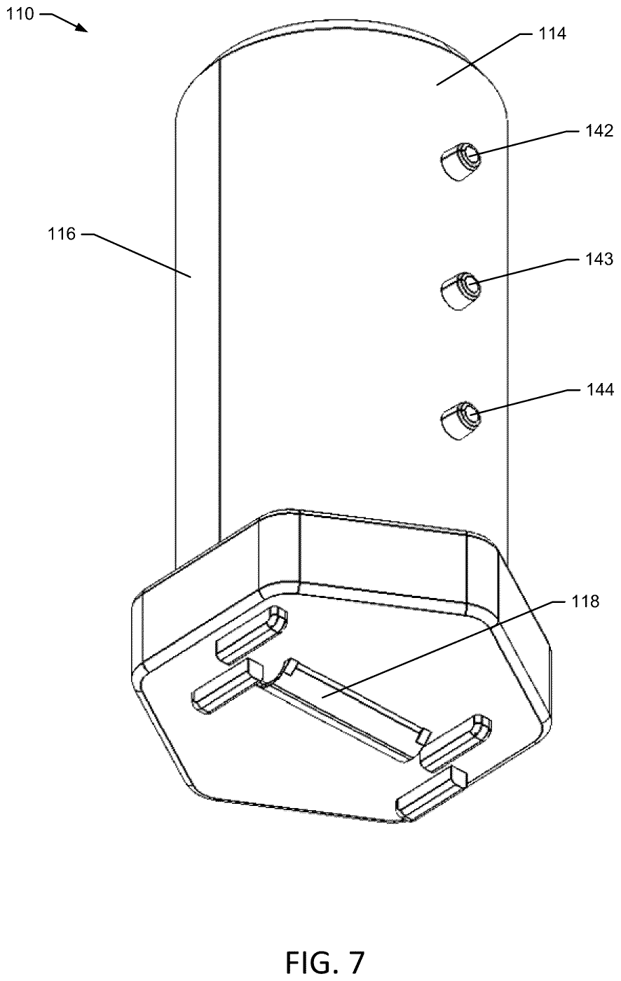

FIG. 7 illustrates a perspective view of the base portion 110 according to an example embodiment. FIG. 7 highlights the living hinge 118 of an example embodiment of the base portion 110 shown in the closed position. As shown in FIG. 7, the base portion 110 may include a first half 114 and a second half 116. In some cases, the first half 114 and the second half 116 may operably couple to each other via a snap fit to form the substantially cylindrical shape of the base portion 110 when in the closed position. The living hinge 118 may include a flexible extension of the polymer material that comprises the first and second halves (114, 116) of the base portion 110. The living hinge 118 may thus allow the base portion 110 to pivot between open and closed positions. In some embodiments, the living hinge 118 may be formed during the same injection molding process as the rest of the base portion 110. In some cases, the base portion 110 may also include a theft deterrent device affixed thereto. The theft deterrent device may be retained inside of the base portion 110 such that it may be hidden out of sight. In this regard, the base portion 110 may be made from an opaque polymer so as to hide the contents contained within the base portion 110 from being viewed from outside the base portion 110. In some embodiments, the theft deterrent device may be an RFID tag.

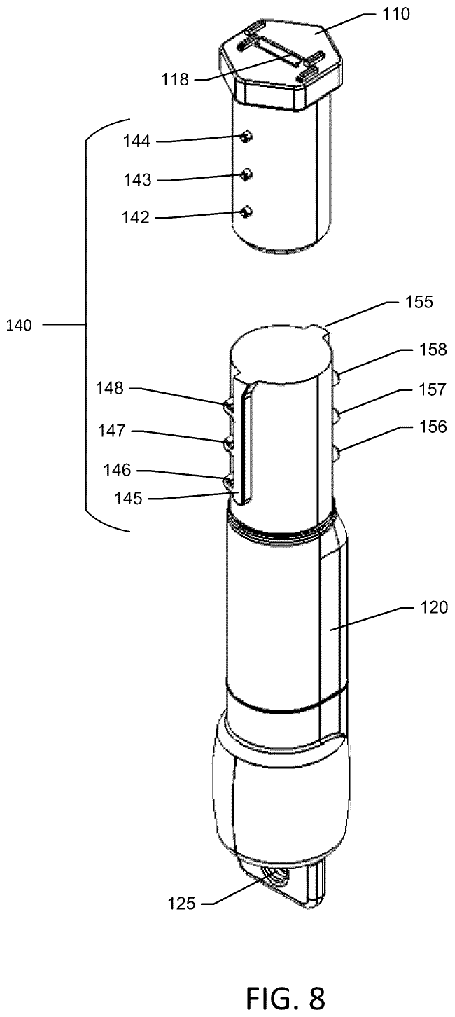

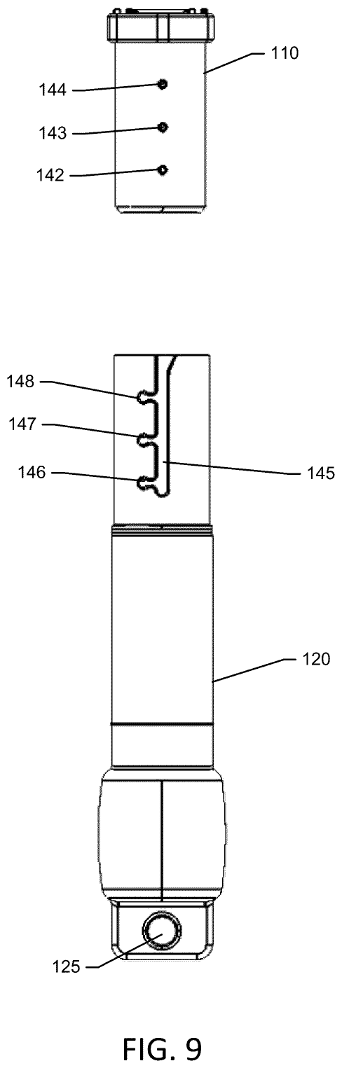

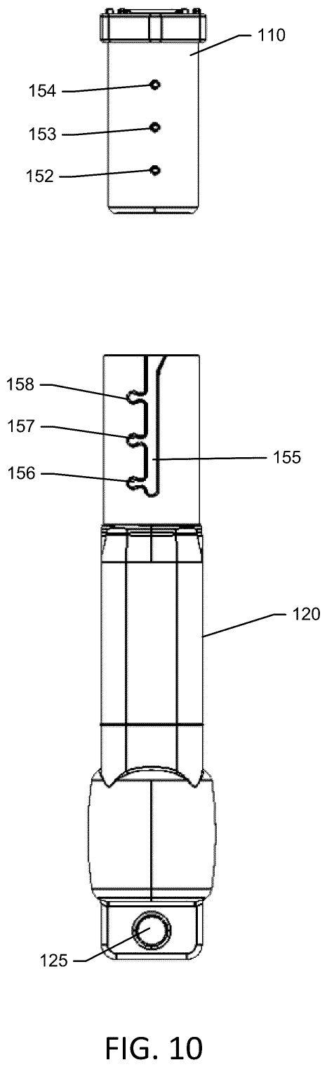

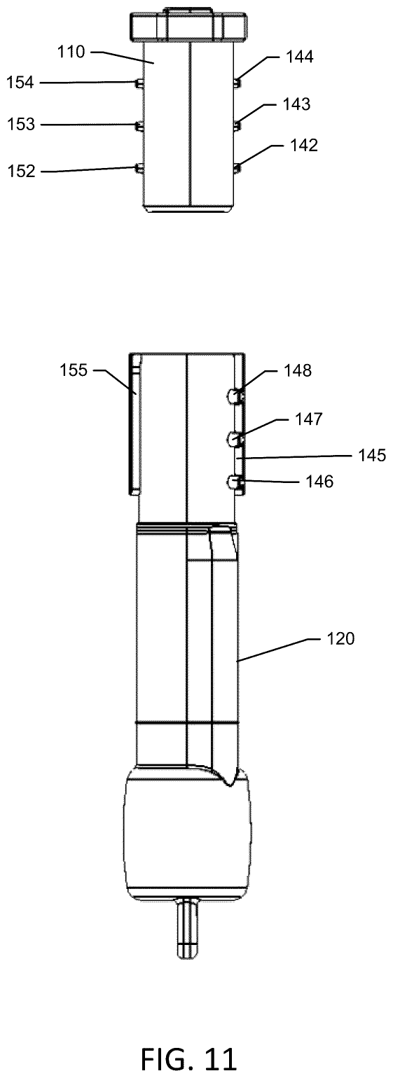

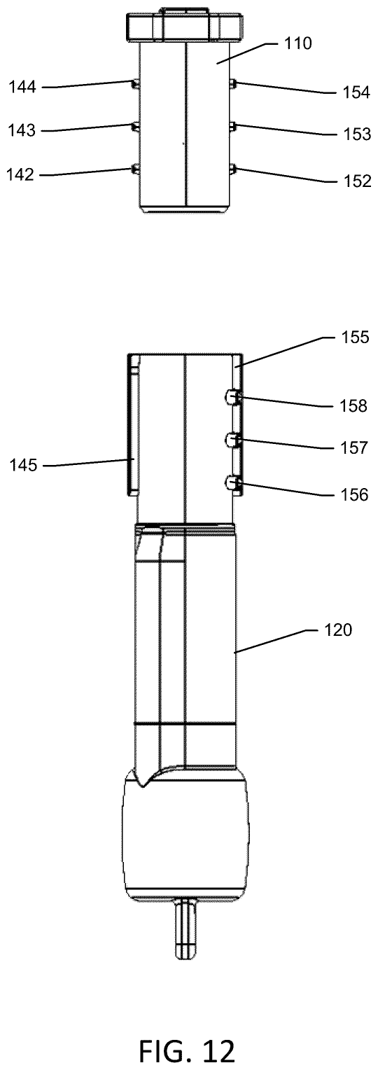

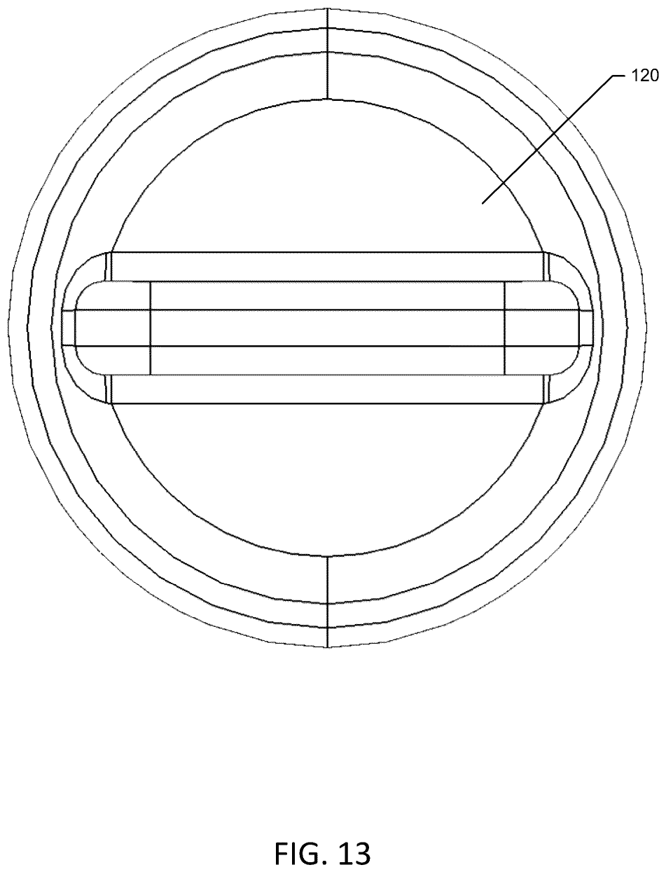

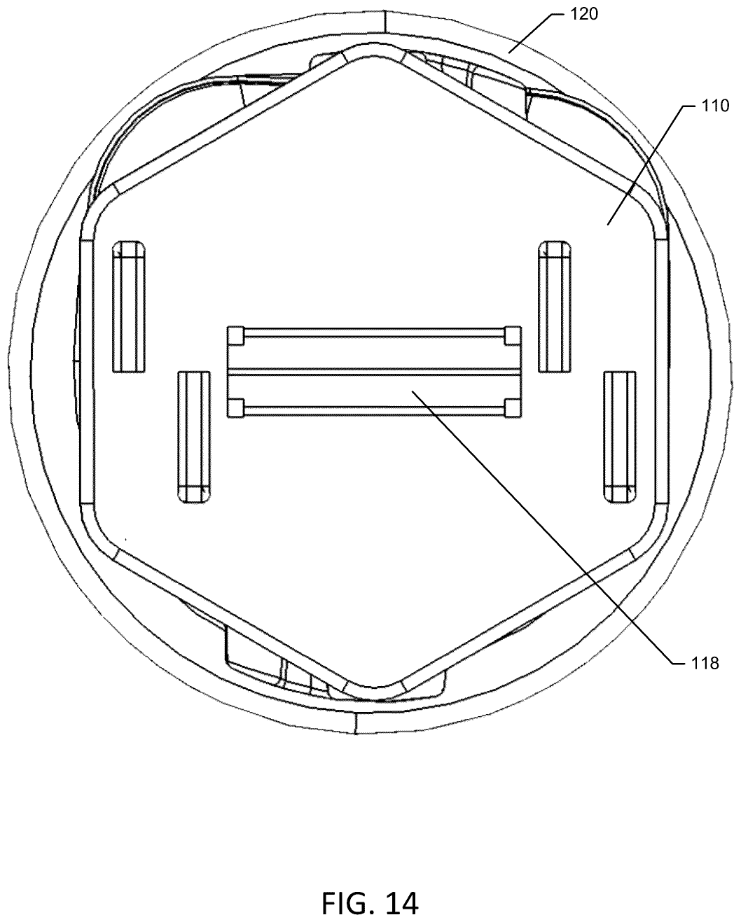

FIGS. 8-14 illustrate a plurality of views of the storage assembly 100 according to an example embodiment. In the embodiment shown in FIGS. 8-14, the base portion 110 may include first, second, third, fourth, fifth and sixth protrusions (142, 143, 144, 152, 153, 154). The fourth, fifth and sixth protrusions (152, 153, 154) may interface with the second guide channel 155 and with corresponding fourth, fifth and sixth reception slots (156, 157, 158), respectively, which may be disposed at the cover member 120.

Thus, according to an example embodiment, a storage assembly for a tool accessory may be provided. The storage assembly may include a cover member which may be configured to cover a first end of the tool accessory, a base portion which may be configured to retain a second end of the tool accessory in an orifice, and a retention assembly which may slidably operably couple the cover member to the base portion. The retention assembly may include a first protrusion which may be disposed at the base portion, a guide channel which may be disposed at the cover member, and a first reception slot which may extend substantially perpendicular to the guide channel. The guide channel may be substantially parallel to a longitudinal axis of the storage assembly. The first protrusion may interface with the guide channel and the first reception slot. The first protrusion may be retainable in the first reception slot responsive to rotating the base portion relative to the cover member.

In some cases, the storage assembly described above may be augmented or modified by altering individual features mentioned above or adding optional features. The augmentations or modifications may be performed in any combination and in any order. For example, in some cases, the base portion may rotate less than 90° relative to the cover member to retain the first protrusion in the first reception slot. In an example embodiment, the first reception slot may include a detent to retain the first protrusion in the first reception slot via a snap fit responsive to rotating the base portion relative to the cover member until the first protrusion moves passed the detent. In some cases, the guide channel may include at least one sloped surface forming an entryway to enable the first protrusion to enter the guide channel responsive to the base portion sliding into the cover member. In an example embodiment, the retention assembly may further include second and third protrusions and second and third reception slots. In some cases, the first, second, and third protrusions may be disposed spaced apart from each other along a line that extends parallel to the longitudinal axis. In an example embodiment, the retention assembly may further include a second protrusion, a second guide channel and a second reception slot. In some cases, the first and second guide channels may be disposed 180° apart on the cover member relative to the longitudinal axis. In an example embodiment, the first and second protrusions may be disposed 180° apart on the base portion relative to the longitudinal axis. In some cases, the cover member may be a unitary molded tube with which the base portion may be slidably operably coupled. In an example embodiment, the base portion may include a first half and a second half. In some cases, the first half and the second half may operably couple to each other via a snap fit to form the orifice. In an example embodiment, the first half of the base portion and the second half of the base portion may be operably coupled via a living hinge disposed opposite the orifice. In some cases, the cover member may include a display interface configured to facilitate mounting the storage assembly on a merchandise display.

According to an example embodiment, a base portion configured to slidably operably couple with a cover member of a tool accessory storage assembly may be provided. The base portion may include a first half and a second half which may be pivotally operably coupled to each other via a living hinge, an orifice which may be disposed opposite the living hinge to retain a tool accessory between the first half and the second half when the first and second halves may be proximate to each other, and a first protrusion which may be disposed on the first half or the second half and may interface with a guide channel and a first reception slot of the cover member. The first protrusion may be retainable in the first reception slot responsive to rotating the base portion relative to the cover member.

According to an example embodiment, a cover member which may be configured to slidably operably couple with a base portion of a tool accessory storage assembly to cover a tool accessory may be provided. The cover member may include a unitary molded tube, a guide channel which may extend substantially parallel to a longitudinal axis of the storage assembly, and a first reception slot which may extend substantially perpendicular to the guide channel. The guide channel may interface with a first protrusion of the base portion. The first reception slot may retain the first protrusion responsive to rotating the cover member relative to the base portion.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

That which is claimed:

1. A storage assembly for a tool accessory, the storage assembly comprising:
a cover member configured to cover a first end of the tool accessory;
a base portion configured to retain a second end of the tool accessory in an orifice; and
a retention assembly slidably operably coupling the cover member to the base portion,
wherein the retention assembly comprises:
a first protrusion disposed at the base portion;
a guide channel disposed at the cover member; and
a first reception slot extending substantially perpendicular to the guide channel,
wherein the guide channel is substantially parallel to a longitudinal axis of the storage assembly,
wherein the first protrusion interfaces with the guide channel and the first reception slot, and
wherein the first protrusion is retainable in the first reception slot responsive to rotating the base portion relative to the cover member.

2. The storage assembly of claim 1, wherein the base portion rotates less than 90° relative to the cover member to retain the first protrusion in the first reception slot.

3. The storage assembly of claim 1, wherein the first reception slot comprises a detent to retain the first protrusion in the first reception slot via a snap fit responsive to rotating the base portion relative to the cover member until the first protrusion moves passed the detent.

4. The storage assembly of claim 1, wherein the guide channel comprises at least one sloped surface forming an entryway to enable the first protrusion to enter the guide channel responsive to the base portion sliding into the cover member.

5. The storage assembly of claim 1, wherein the retention assembly further comprises second and third protrusions and second and third reception slots, and wherein the first, second, and third protrusions are disposed spaced apart from each other along a line that extends parallel to the longitudinal axis.

6. The storage assembly of claim 1, wherein the retention assembly further comprises a second protrusion, a second guide channel and a second reception slot,
wherein the first and second guide channels are disposed 180° apart on the cover member relative to the longitudinal axis, and
wherein the first and second protrusions are disposed 180° apart on the base portion relative to the longitudinal axis.

7. The storage assembly of claim 1, wherein the cover member is transparent and the base portion is opaque.

8. The storage assembly of claim 1, wherein the base portion comprises a first half and a second half,
wherein the first half and the second half operably couple to each other via a snap fit to form the orifice.

9. The storage assembly of claim 8, wherein the first half of the base portion and the second half of the base portion are operably coupled via a living hinge disposed opposite the orifice.

10. The storage assembly of claim 1, wherein the cover member comprises a display interface configured to facilitate mounting the storage assembly on a merchandise display, and
wherein the base portion comprises a theft deterrent device.

11. A base portion configured to slidably operably couple with a cover member of a tool accessory storage assembly, wherein the base portion comprises:
a first half and a second half pivotally operably coupled to each other via a living hinge;
an orifice disposed opposite the living hinge to retain a tool accessory between the first half and the second half when the first and second halves are proximate to each other; and
a first protrusion disposed on the first half or the second half to interface with a guide channel and a first reception slot of the cover member,
wherein the first protrusion is retainable in the first reception slot responsive to rotating the base portion relative to the cover member.

12. The base portion of claim 11, wherein the base portion rotates less than 90° relative to the cover member to retain the first protrusion in the first reception slot.

13. The base portion of claim 11, wherein the first protrusion moves passed a detent in the first reception slot to be retained in the first reception slot via a snap fit responsive to rotating the base portion relative to the cover member.

14. The base portion of claim 11, wherein the first half and the second half are separated from each other by a longitudinal axis of the storage assembly, and wherein the orifice comprises a receptacle disposed therein in order to removably retain the tool accessory within the base portion.

15. The base portion of claim 11, wherein the base portion further comprises second and third protrusions configured to interface with second and third reception slots on the cover member, and
wherein the first, second, and third protrusions are disposed spaced apart from each other along a line parallel to the longitudinal axis.

16. A cover member configured to slidably operably couple with a base portion of a tool accessory storage assembly to cover a tool accessory, wherein the cover member comprises:
a unitary molded tube;
a guide channel extending substantially parallel to a longitudinal axis of the storage assembly; and
a first reception slot extending substantially perpendicular to the guide channel,
wherein the guide channel interfaces with a first protrusion of the base portion, and
wherein the first reception slot retains the first protrusion responsive to rotating the cover member relative to the base portion.

17. The cover member of claim 16, wherein the cover member rotates less than 90° relative to the base portion so the first reception slot retains the first protrusion.

18. The cover member of claim 16, wherein the first reception slot comprises a detent to retain the first protrusion in the first reception slot via a snap fit responsive to rotating the cover member relative to the base portion until the first protrusion moves passed the detent.

19. The cover member of claim 16, wherein the guide channel comprises at least one sloped surface forming an entryway to enable the first protrusion to enter the guide channel responsive to the base portion sliding into the cover member.

20. The cover member of claim 16, wherein the cover member comprises a display interface configured to facilitate mounting the storage assembly on a merchandise display.
